(19) United States
(12) Patent Application Publication
(10) Pub. No.: US 2022/0332619 A1
(43) Pub. Date: Oct. 20, 2022

(54) POWER STORAGE AND SALT WATER CLEANING SYSTEM

(71) Applicant: FMC Technologies, Inc., Houston, TX (US)

(72) Inventors: Gabriel Silva, Houston, TX (US); Stefano Passerini, Ulm (DE); Dominic Bresser, Ulm (DE); Jens Peters, Madrid (ES); Marcel Weil, Offenburg (DE); Jens Federhen, Karlsruhe (DE)

(73) Assignee: FMC Technologies, Inc., Houston, TX (US)

(21) Appl. No.: 17/753,855

(22) PCT Filed: Sep. 16, 2020
(86) PCT No.: PCT/US2020/051051

§ 371 Date: Mar. 16, 2022

Related U.S. Application Data
(60) Provisional application No. 62/901,482, filed on Sep. 17, 2019.

(51) Int. Cl. C02F 9/00; H01M 4/66; H01M 4/80; H01M 4/583; H01M 50/51

(52) U.S. Cl. CPC C02F 9/00; H01M 4/661; H01M 4/808; H01M 4/583; H01M 4/663; H01M 4/806; H01M 50/51; H01M 2004/027

(57) ABSTRACT

An electrochemical cell may include: an anode; a porous anodic current collector; a cathode; a porous cathodic current collector; and an alkali metal-conducting separator that separates the anode from the cathode and is disposed surrounding the anodic current collector. The cathode may include seawater. A battery module may include a plurality of the electrochemical cells, and a battery may include a plurality of the battery modules.

### BACKGROUND

Transportable power storage has been dominated by lithium-based battery technology. The demand for such electrical power is increasing with the electrification of transportation, such as electric vehicles, and with the increasing ubiquity of portable consumer electronics. Generally, Li-ion batteries are able to deliver power on the microwatt to kilowatt scale, with megawatt-capability batteries only being recently developed. Large capacity lithium-based batteries may use materials that are expensive to produce and dispose of.

The ability to store megawatt hours of energy is necessary for grid and renewable energy applications. Currently, large-scale flow batteries are being developed for such applications due to their stability and scalability compared to lithium-based batteries. Flow batteries use a pair of chemical components that are circulated through a cell, generating electricity from chemical energy. However, flow batteries are generally stationary as transportation of these batteries is highly regulated for safety and environmental concerns, adding substantial limitations and costs, and may have limitations in cycling longevity for offshore applications in oil and gas and renewables.

Both lithium-ion and typical flow batteries may use electrolytes and materials that are harmful to the environment and difficult to dispose of. The accumulation of these factors inhibits the implementation of large power storage offshore, subsea, and in remote locations onshore to satisfy energy needs.

### SUMMARY OF INVENTION

This summary is provided to introduce a selection of concepts that are further described below in the detailed description. This summary is not intended to identify key or essential features of the claimed subject matter, nor is it intended to be used as an aid in limiting the scope of the claimed subject matter.

In one aspect, embodiments disclosed herein may relate to electrochemical cells that include: an anode; a porous anodic current collector; a cathode; a porous cathodic current collector; and an alkali metal-conducting separator that separates the anode from the cathode and is disposed surrounding the anodic current collector. The cathode may include seawater. A battery module of one or more embodiments may include a plurality of the electrochemical cells. A battery of one or more embodiments may include a plurality of the battery modules.

In a further aspect, embodiments disclosed herein may relate to a battery that has a capacity of 3 MWh or more and includes a plurality of electrochemical cells, where each electrochemical cell includes: a seawater cathode; and a NASICON (sodium super ionic conductor) membrane. In another aspect, embodiments disclosed herein relate to desalination plant, comprising: a pretreatment stage; a filter; a membrane; and a seawater battery.

In a further aspect, embodiments disclosed herein may relate to a method of generating electrical power, the method including: transporting a module to a site; adding seawater to the module at the site to provide a battery; and generating electrical power with the battery. The module may include all of the components of the battery except for the cathode.

In a final aspect, embodiments disclosed herein may relate to a method of desalinating seawater, the method including: flowing the seawater through a battery; and charging the battery with the seawater, wherein the battery includes a plurality of electrochemical cells, each of which includes a separator made of a NASICON membrane.

Other aspects and advantages will be apparent from the following description and the appended claims.

### BRIEF DESCRIPTION OF DRAWINGS

FIG. 1 depicts a schematic illustration of an electrochemical cell that is in accordance with one or more embodiments of the present disclosure.

FIGS. 2A-2C depict a battery module in accordance with one or more embodiments of the present disclosure. FIG. 2A depicts the overall dimensions of a battery module of one or more embodiments. Also shown are air and seawater inlets on the bottom of the module, and an air vent and seawater outlet on the top of the module (as labelled in FIG. 2B). FIG. 2B depicts a battery module of one or more embodiments, showing the arrangement of the cells and the various components of the module. As shown, the seawater and air inlets are located on the bottom of the module, and the seawater and air may laterally pass through the cells. FIG. 2C depicts a staggered arrangement of the cells of one or more embodiments.

FIGS. 3A-B depict a battery in accordance with one or more embodiments of the present disclosure.

FIG. 4 depicts a battery in accordance with one or more embodiments of the present disclosure.

FIG. 5 depicts the use of a battery of one or more embodiments near an offshore structure, in accordance with one or more embodiments of the present disclosure.

FIG. 6 depicts the use of a battery of one or more embodiments near an offshore wind turbine, in accordance with one or more embodiments of the present disclosure.

FIG. 7 depicts the use of a battery of one or more embodiments in a desalination process, in accordance with one or more embodiments of the present disclosure

FIG. 8 depicts the installation of a battery of one or more embodiments in a ship for use and/or transportation.

FIG. 9 depicts the use of a battery of one or more embodiments in an off-shore data center.

### DETAILED DESCRIPTION

One or more embodiments disclosed herein generally relate to electrochemical cells that utilize sodium ions from seawater for the generation of electrical power. Other embodiments disclosed herein are generally directed to battery modules that comprise a plurality of electrochemical cells that may be connected in parallel. Further embodiments are directed to batteries that comprise a plurality of battery modules that utilize sodium ions from seawater for the generation of electrical power. Batteries in accordance with the present disclosure may provide scalable megawatt power storage capacity using sea water and other environmentally-friendly materials, such as sodium and aluminum. In one or more embodiments, batteries of the present disclosure may be safely transported and at a low cost. The battery of one or more embodiments may be a salt water cleaning system. The batteries of some embodiments may be sufficiently scalable to allow for its use in large offshore power storage to support offshore renewables, the oil and gas industry, and sea transporting vessels' needs.

One or more embodiments disclosed herein generally relate to methods of generating electrical power at a given site. Further embodiments are directed to methods of desalinating seawater by using the seawater to generate electrical power. Since the electrolyte for the cathode of one or more embodiments is seawater, the battery may be safely transported empty and charged at the given site, reducing the cost of installation and deployment.

Terms such as “approximately,” “substantially,” etc., are intended to mean that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

Similarly, the terms “can” and “may” and their variants are intended to be non-limiting, such that recitation that an embodiment can or may comprise certain elements or features does not exclude other embodiments of the present technology that do not contain those elements or features. Disclosures of ranges are, unless specified otherwise, inclusive of endpoints and include all distinct values and further divided ranges within the entire range.

### BATTERY CELLS

In one or more embodiments, electrochemical (or battery) cells in accordance with the present disclosure may be sodium-ion flow cells. Sodium-ion batteries are commonly based on raw materials that are less expensive, more abundant and less toxic than battery technologies such as Li-ion. In particular embodiments, the sodium-ions may be sourced from seawater. In other embodiments, any sodium-ion containing solution may be used to provide the sodium ions. Generally, the seawater, or equivalent, may be utilized as a cathode.

In the cells of one or more embodiments, the electrochemical reactions occurring during charge and discharge may be represented by the following equations (I) and (II). In such embodiments, charging the cell consumes salt and evolves chlorine (Equation (I)). Discharging the cell consumes oxygen and water while evolving caustic soda during discharge (Equation (II)).

Charge: 4NaCl→4Na⁺+2Cl₂+4e⁻ (I)

Discharge: 4Na⁺+2H₂O+O₂4e⁻→4NaOH (II)

Notably, the discharged water will generally contain less salt than the incoming seawater. Further, the charging process generates chlorine gas, which may be collected by conventional methods known in the art. The cells of one or more embodiments may comprise an anode, a cathode, an anodic current collector, a cathodic current collector, and a separator that separates the anode from the cathode.

The anode of one or more embodiments may be any suitable conductive material known to one of ordinary skill in the art. In some embodiments, the anode may comprise one or more carbonaceous, zincous, stannous, organic, or phosphorus species, which may be selected from the group consisting of hard carbon, (expanded) graphite, carbon black, zinc, tin, tin oxide, red and black phosphorus, and sodium terephthalate. The anode material may be any suitable material, and its selection may influence the overall capacity of the cell but generally does not affect the overall cell design. In particular embodiments, the anode may consist essentially of hard carbon. In one or more embodiments, the anode may be in particulate form.

The anodic current collector of one or more embodiments may be a porous conductive material, such as a metal foam. In some embodiments, the anodic current collector may be a foam of one or more of the group consisting of aluminum, nickel, copper, and stainless steel. In particular embodiments, the anodic current collector may comprise aluminum foam. In other embodiments, the anodic current collector may consist essentially of an aluminum foam. In other embodiments, the anodic current collector may consist of an aluminum foam. In embodiments where the anode is in particulate form, the void volume of a porous anodic current collector may be at least partially filled with a slurry of anodic material and an electrolyte. In particular embodiments, the void volume of the anodic current collector may be substantially filled with a slurry of anodic material and an electrolyte. The electrolyte may be any suitable electrolyte known in the art, and it may be selected according to factors such as cost restrictions and power needs. In some embodiments, the electrolyte may be an ionic liquid. The electrolyte of particular embodiments may be a cyanimide-based ionic liquid.

In one or more embodiments, the active anodic material may comprise the anode in an amount ranging from about 55 to 65% and the electrolyte in an amount ranging from about 25 to 35%, by weight. In other embodiments, a cell may comprise the anode in an amount ranging from about 50 to 70% and the electrolyte in an amount ranging from about 40 to 20%, by weight.

In one or more embodiments, the anodic current collector will pass through a seal to the exterior of the cell. The anodic current collector that passes through the seal may comprise a wire that is electrically connected to the porous conductive material described above. The seal may be made of any suitable material known to one of the art. In particular embodiments, the seal may be made of epoxy. In such instances, the anodic current collector on the exterior of the cell may be electrically isolated by an insulating coating to prevent current leakage. The coating may comprise any suitable material. In some embodiments, the coating may comprise a polymer that is, for example, stable to exposure to chlorine, sodium hydroxide, aluminum chloride, and sulfur dioxide. The coating of particular embodiments may comprise polyvinyl chloride (PVC).

The cathode of one or more embodiments may comprise a sodium-ion containing solution. In some embodiments, the sodium-ion containing solution may particularly be an aqueous solution such as seawater. The sodium-ion content of the sodium-ion containing solution is not particularly limited and may be any content that is found in seawater. In one or more embodiments, the sodium-ion containing solution may comprise sodium chloride in an amount ranging from a lower limit of 25, 35, 40 or 45 g/kg, to an upper limit of 40, 45, or 50 g/kg, where any lower limit may be used in combination with any mathematically-compatible upper limit.

The seawater of one or more embodiments may comprise the effluent of a desalination plant. One of ordinary skill will appreciate that the sodium content of said effluent may be substantially higher than is typically found in seawater. The use of seawater may provide an essentially unlimited sodium reservoir and, thus, basically an unlimited cycle life in absence of other aging phenomena. Thus, the energy density may eventually be limited only by the capacity of the anode and the overall cell design.

The sodium-ion containing solution of one or more embodiments may be pumped through the electrochemical cell so as to provide a flow of sodium ions. In some embodiments, the cell may be arranged vertically and the water pumped through the cell laterally. Air may be injected into the cell to provide the oxygen required for the discharge reaction (Equation (II) above). The air may be injected into the bottom of the cell of one or more embodiments.

The cathodic current collector of one or more embodiments may be a porous conductive material. In some embodiments, the cathodic current collector may comprise a metal such as one or more of aluminum, nickel, and stainless steel, or a carbonaceous species, which may be selected from the group consisting of hard carbon, graphite, activated carbon, carbon black, and graphene. In particular embodiments, the cathodic current collector may comprise a carbon felt. In other embodiments, the cathodic current collector may consist essentially of a carbon felt. In other embodiments, the cathodic current collector may consist of a carbon felt. It is noted that in embodiments where the cathode comprises seawater, a cathodic electrolyte is not necessarily required because of the conductive nature of seawater.

The separator of one or more embodiments may comprise any suitable ion-conductive material that is known to one of ordinary skill in the art. In some embodiments, the separator may comprise a sodium super ionic conductor (NASICON). In particular embodiments, the separator may consist essentially of NASICON. In one or more embodiments, the separator may consist of a NASICON ceramic membrane. The NASICON of one or more embodiments may have a chemical formula of Na₁₊ₓZr₂SiₓP₃₋ₓO₁₂, where 0≤x≤3. In some embodiments, the NASICON may be Na₃Zr₂Si₂PO₁₂.

The cells of one or more embodiments may further comprise an additional metal structure that increases conductivity and mechanical stability. The metal structure may comprise one or more of the group consisting of aluminum, nickel, and stainless steel. The metal structure of one or more embodiments may be a stainless steel-wire mesh.

The battery cells of one or more embodiments may be tubular cells. Battery cells may be cylindrical in shape and comprise the anode and anodic current collector radially-centered in the cell. The anode and anodic current collector may be isolated from the cathode by the separator. The anodic current collector may be cylindrical in shape and, in some embodiments, may be surrounded by the separator. The cell of one or more embodiments may comprise a cathodic current collector that is cylindrical in shape and may be disposed around the separator.

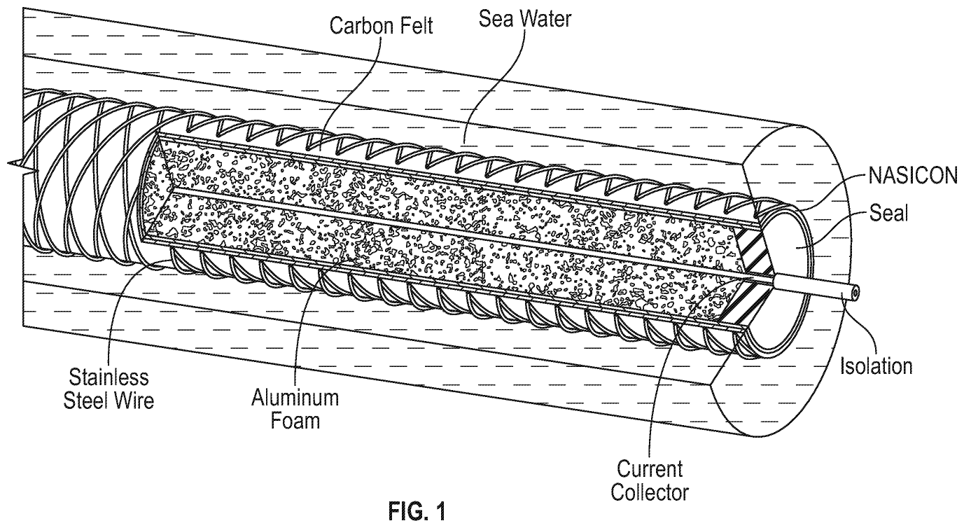

A battery cell of one or more embodiments is represented by FIG. 1. Said battery cell comprises a cylindrical aluminum foam anodic current collector that is surrounded by a separator made of NASICON ceramic membrane. The void volume of the aluminum foam is filled with a slurry of hard carbon anodic material and an electrolyte. In some embodiments, the electrolyte may be a cyanamide-based ionic liquid or a SO₂-based inorganic ionic liquid. The NASICON membrane is coated by a porous carbon felt cathodic current collector and a seawater cathode. The NASICON film separates the anode from the cathode. A stainless-steel wire mesh compresses the cathodic current collector and increases conductivity. The anodic current collector passes through a seal of epoxy. Outside the cell, the current collector is isolated from the surrounding seawater by a polymer coating.

The battery cell of one or more embodiments may have a diameter ranging from about 2 to 30 mm. For example, the battery cell may have a diameter ranging from a lower limit of any one of 2, 5, 10, 15, and 20 mm, to an upper limit of any one of 5, 10, 15, 20, 25, and 30 mm, where any lower limit may be paired with any mathematically-compatible upper limit. The battery cell of particular embodiments may have a diameter of approximately 20 mm. The battery cell of one or more embodiments may have a length ranging from about 200 to 500 mm. In some embodiments, the battery cell may have a length ranging from about a lower limit of any one of 10, 20, 50, 100, 200, 250, and 300 mm, to about an upper limit of any one of 20, 50, 100, 200, 300, 350, 400 and 500 mm, where any lower limit may be paired with any mathematically-compatible upper limit. The physical dimensions of battery cells in accordance with one or more embodiments of the present disclosure may be varied within a reasonable range to modify certain aspects of the design of the module and power needs. For instance, in some embodiments, the smaller the diameter, the higher the potential charge/discharge rate, but the larger the diameter, the higher the energy density.

A battery cell of one or more embodiments may provide a voltage ranging from a lower limit of any one of 1, 1.5, 2, 2.5, and 3 V, to an upper limit of any one of 3, 3.5, and 4 V, where any lower limit may be paired with any mathematically-compatible upper limit. In particular embodiments, the battery cell may provide a voltage of about 3 V.

A battery cell of one or more embodiments may have a cycle life ranging from a lower limit of any one of 200, 500, 1000, 2500, or 5000 cycles, to an upper limit of any one of 1000, 3000, 5000, or 10000 cycles, where any lower limit may be paired with any mathematically-compatible upper limit. In particular embodiments, a battery cell may have a cycle life of at least 200 cycles, at least 500 cycles, at least 1000 cycles, or at least 5000 cycles.

A battery cell of one or more embodiments may have a charge rate and a discharge rate that are approximately the same. In some embodiments, a battery cell of one or more embodiments may have a charge rate (where C is a one-hour charge rate) ranging from a lower limit of any one of C/100, C/50, C/20, C/10, or C/5, to an upper limit of any one of C/10, C/5, C/2, C, or 2C, where any lower limit may be paired with any mathematically-compatible upper limit. In same embodiments, a battery cell of one or more embodiments may have a discharge rate (where C is a one-hour discharge rate) ranging from a lower limit of any one of C/100, C/50, C/20, C/10, or C/5, to an upper limit of any one of C/10, C/5, C/2, C, or 2C, where any lower limit may be paired with any mathematically-compatible upper limit.

One of ordinary skill in the art will appreciate, with the benefit of this disclosure, that battery cells in accordance with the present disclosure are not limited to those explicitly disclosed above and may be adjusted according to the specific requirements of its application.

### BATTERY MODULES

In one or more embodiments, battery modules in accordance with the present disclosure may comprise a plurality of electrochemical cells. The battery modules may particularly comprise a plurality of the aforementioned electrochemical cells. The plurality of cells may be connected in parallel by a common busbar. However, in some embodiments, the cells may be connected in series. One of ordinary skill in the art will appreciate, with the benefit of this disclosure, that the selection of parallel or series will depend upon the voltage and current demands of the battery's intended application. Within a battery module of one or more embodiments, the cells may be connected in parallel, so that the module voltage may be equal to that of the cells. For instance, if the cells provide a voltage of 3 V, the module may also provide a voltage of 3 V.

The exact number of cells that a battery module contains is not particularly limited and may be selected based upon the voltage and current demands of the battery's intended application. Considering the available width and height as well as voltage and capacity requirements of a battery module, in particular embodiments, the number of cells in a module may be about 212. In some embodiments, a module may have a number of cells ranging from a lower limit of any one of 10, 25, 50, 100, 150, 200, or 250, to an upper limit of any one of 100, 200, 250, 300 or 500, where any lower limit may be paired with any mathematically-compatible upper limit.

The battery module of some embodiments may comprise a metallic structure that may secure individual cells in place, provide structural stability, and/or serve as one or more of the cathode current collector and busbar. The metallic structure may be made of one or more of the group consisting of aluminum, nickel, copper, silver, zinc, stainless steel, and lead, though it may particularly be made of aluminum.

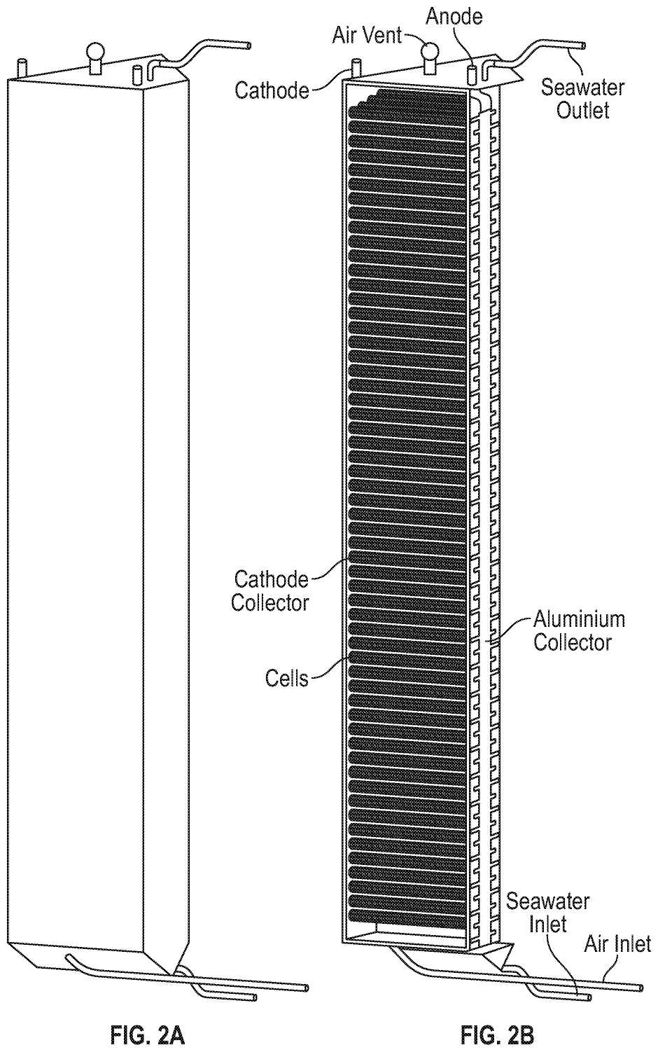

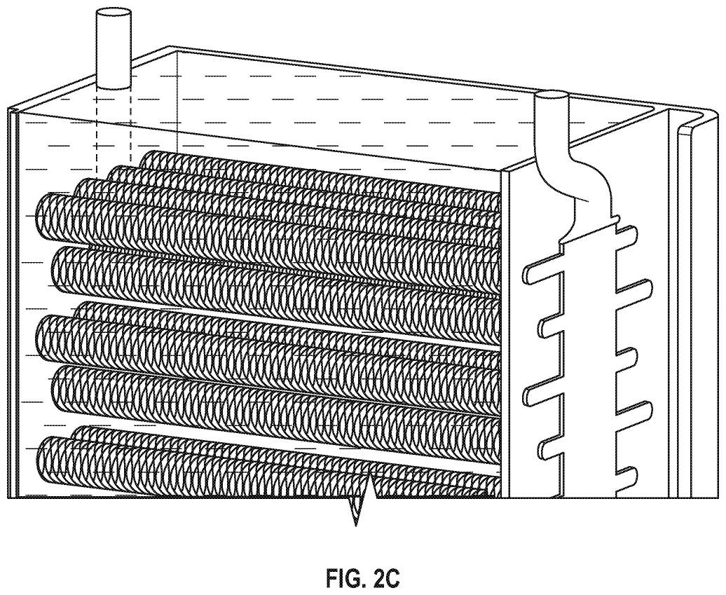

The overall dimensions of a battery module of one or more embodiments are not particularly limited. The minimum width of a module may be determined by the wall thickness of the housing, the dimensions of collectors/busbars and other connections, and the size of the cells. In an example configuration, the overall module width may be about 350 mm. See FIG. 2A. In some embodiments, a module may have a width ranging from a lower limit of any one of 50, 100, 200, 300, or 500 mm to an upper limit of any one of 200, 300, 400, 500, or 750 mm, where any lower limit may be paired with any mathematically-compatible upper limit.

The height of a module may be determined, at least in part, by the total number of cells that the module contains, and their spacing. In some embodiments, the overall height of the individual modules is limited by the container height and supply line diameters. In an example configuration, the overall module height may be about 2 m. See FIG. 2A. In some embodiments, a module may have a height ranging from a lower limit of any one of 0.5, 1.0, 1.5, 2.0, and 2.5 m to an upper limit of any one of 1.0, 1.5, 2.0, 2.5, 3.0, and 4.0 m, where any lower limit may be paired with any mathematically-compatible upper limit.

The depth of a module may be determined, at least in part, by the total number of cells that the module contains, and their spacing. In an example configuration, the overall module depth may be about 0.195 m. See FIG. 2A. In some embodiments, a module may have a depth ranging from a lower limit of any one of 0.10, 0.14, 0.18, 0.20, and 0.22 m to an upper limit of any one of 0.16, 0.18, 0.20, 0.22, and 0.30 m, where any lower limit may be paired with any mathematically-compatible upper limit.

The modules of one or more embodiments may be connected with water and air supply lines. The components of an example battery module of one or more embodiments is represented by FIG. 2B.

The cell layout of a battery module of one or more embodiments is not particularly limited but may be as compact as possible while still ensuring sufficient seawater and air supply to every cell. The spatial distribution of the cells within each module may be optimized according to the water and air flow requirements to provide low flow resistance. In some embodiments, the cell layout may comprise a staggered arrangement. The cell layout of an example battery module of one or more embodiments is shown by FIG. 2C. In one or more embodiments, the flow of seawater may be selected to ensure that substantially all chlorine that is generated is dissolved in the seawater. In some embodiments, the mass flow of seawater may range from about 150 to 250 m³ per charge/discharge cycle. In some embodiments, the mass flow of seawater may be about 0.05 to 0.15 m³ per battery module.

In some embodiments, the sodium-ion containing solution, such as seawater, may be pumped through the battery module so as to pass through the cells laterally (through the shortest dimension of the cell). Air may be fed to the modules through a separate manifold to ensure sufficient oxygen supply. The manifold may inject air at the bottom of the module, ensuring that the sodium-ion containing solution is saturated with oxygen during discharge. In some embodiments, the battery modules may be arranged vertically, allowing the injected air to rise to the top of the module while passing through the battery cells. Excess air may be purged from a module by means of a gas separator or air vent.

A metal busbar may connect each cell of a module of one or more embodiments in parallel. The metal may be one or more of the group consisting of aluminum, nickel, copper, silver, zinc, stainless steel, and lead. In particular embodiments, the busbar may be an aluminum busbar. A battery module of one or more embodiments may provide a current ranging from a lower limit of any one of 100, 200, 300, 400, 500, or 600 A, to an upper limit of any one of 500, 600, 700, 800, or 1000 A, where any lower limit may be paired with any mathematically-compatible upper limit. In particular embodiments, a battery module may provide a voltage of about 540 A.

The dimensions of the busbar are influenced by the total current provided by the module, and the material that the busbar is made from. For instance, as aluminum has a higher specific resistance than copper, the minimum cross-sectional area of an aluminum busbar must be approximately 1.6 times that of copper. In some embodiments, an aluminum busbar will have a cross-sectional area of about 592 mm². The busbars of one or more embodiments may have a thickness ranging from 3 to 4 mm. In some embodiments the busbars may be about 3.3 mm thick. The busbars may have a trapezoidal shape and, in some embodiments, be connected directly with another module or with the next row of modules via a cable.

The housing of the battery module of one or more embodiments is not particularly limited but should be selected to mechanically support its contents. In one or more embodiments, the housing should be substantially chemically resistant to seawater while still allowing cost-effective production and assembly. In some embodiments, the housing should also be resistant to the operational levels of chlorine and caustic soda, which are generated by the charge and discharge processes. Example materials include plastics such as PVC. The housing may have a uniform wall thickness of about 6 mm. The module design of one or more embodiments may not necessarily feature any methods of maximizing stiffness, such as beads.

The battery module may comprise four parts: two manifolds, a cuboidal tube that houses the cells, and a separating sheet. See FIG. 2B. The first manifold may serve as a water and air inlet. The first manifold may comprise supply pipes that are connected via fittings, installed in preformed holes and sealed with tapered threads. The second manifold, which may be installed at the top of the module, may feature a water outlet fitting, a gas separator, and openings for connecting the busbars. Cells may be fixed via the cathode current collector and separating sheet and assembled as a unit together with the anode busbar. The assembly is merged and welded with the outer tube, providing water tightness. The manifolds may be sufficiently long as to avoid significant current flows through the seawater.

One of ordinary skill in the art will appreciate, with the benefit of this disclosure, that battery modules in accordance with the present disclosure are not limited to those explicitly disclosed above and may be adjusted according to the specific requirements of its application.

### BATTERIES

In one or more embodiments, batteries in accordance with the present disclosure may comprise a plurality of battery modules. The batteries may particularly comprise a plurality of the aforementioned battery modules. The plurality of battery modules may, in some embodiments, be connected in series by a busbar. However, in other embodiments, the cells may be connected in parallel. One of ordinary skill in the art will appreciate, with the benefit of this disclosure, that the selection of series or parallel will depend upon the voltage and current demands of the battery's intended application

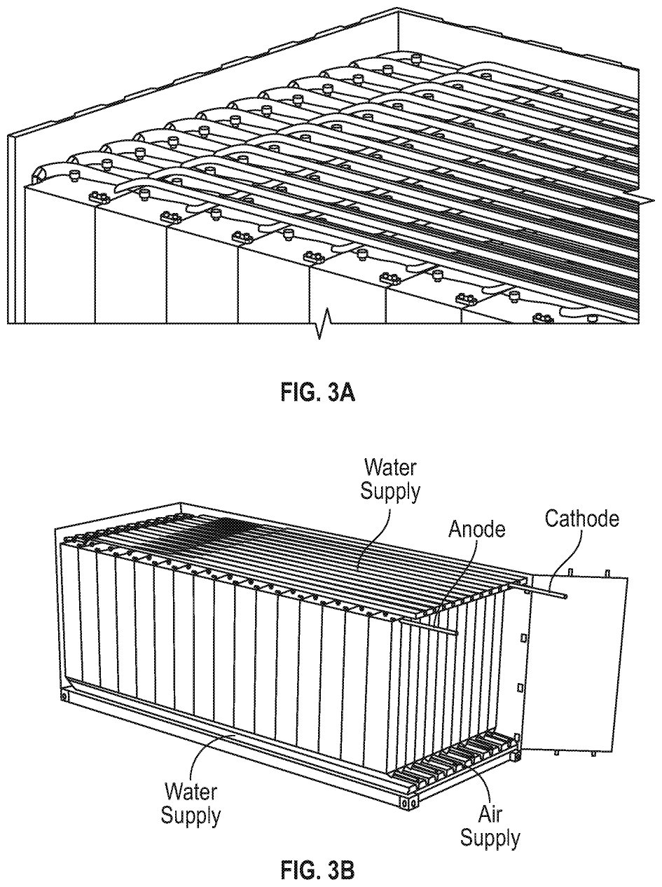

In particular embodiments, the battery modules may be arranged in rows. The modules of each row may be connected in series by the busbar that may be made of one or more of the group consisting of aluminum, nickel, copper, silver, zinc, stainless steel, and lead. In particular embodiments the busbar may be made of aluminum. The rows of modules may be connected with, for example, copper cables on top of the modules. See FIGS. 3A and 3B.

The exact number of modules, and cells, that a battery contains is not particularly limited and may be selected based upon the voltage and current demands of the battery's intended application. A battery of one or more embodiments may comprise a number of battery modules ranging from about a lower limit of any one of 50, 100, 150, 200, and 250, to about an upper limit of any one of 100, 150, 200, 250, or 500, where any lower limit may be paired with any mathematically-compatible upper limit

A battery of one or more embodiments may have a capacity ranging from about a lower limit of any one of 0.5, 1, 2, 3, 4, 5, and 10 MWh, to about an upper limit of any one of 1, 3, 5, 10, and 15 MWh, where any lower limit may be paired with any mathematically-compatible upper limit. In particular embodiments, the battery may have a capacity of 0.5 MWh or more, 1 MWh or more, 2 MWh or more, 3 MWh or more, 4 MWh or more, 5 MWh or more, or 10 MWh or more. Batteries in accordance with one or more embodiments of the present disclosure are generally highly scalable, allowing for the provision of very high capacities.

A battery of one or more embodiments may have a power ranging from about a lower limit of any one of 100, 200, 300, or 500 kW, to about an upper limit of any one of 400, 500, 750, or 1000 kW, where any lower limit may be paired with any mathematically-compatible upper limit. In particular embodiments, the battery may have a power of 200 kW or more, 300 kW or more, 400 kW or more, or 500 kW or more.

A battery of one or more embodiments may provide a voltage ranging from about a lower limit of any one of 100, 200, 300, 400, or 500 V, to about an upper limit of any one of 500, 600, 750, or 1000 V, where any lower limit may be paired with any mathematically-compatible upper limit. The batteries of particular embodiments may provide a voltage of about 576 V. In batteries of one or more embodiments where the battery modules are connected in series, the voltage provided by the battery will be approximately the sum of the voltages provided by the battery modules. The number of battery modules that are connected in series may be the number required to provide a desired voltage.

A battery of one or more embodiments may provide a current ranging from a lower limit of any one of 100, 200, 300, 400, 500, or 600 A, to an upper limit of any one of 500, 600, 700, 800, or 1000 A, where any lower limit may be paired with any mathematically-compatible upper limit. In particular embodiments, a battery module may provide a voltage of about 540 A. In batteries of one or more embodiments where the battery modules are connected in series, the current provided by the battery will be approximately the same as the current provided by one battery module.

A battery of one or more embodiments may have a cycle life ranging from a lower limit of any one of 200, 500, 1000, 2500, or 5000 cycles, to an upper limit of any one of 1000, 3000, 5000, or 10000 cycles, where any lower limit may be paired with any mathematically-compatible upper limit. In particular embodiments, a battery may have a cycle life of at least 200 cycles, at least 500 cycles, at least 1000 cycles, or at least 5000 cycles.

The battery system may be mounted in a standard shipping container for easy transport and handling. Depending on the configuration, the battery may contain at least a plurality of battery modules, inlet and outlet tubes, and electrical connections. The battery of one or more embodiments may further comprise peripheral devices. Peripheral devices may include one or more of, for example, a battery management component, a filtration component, an air compressor (which may supply a sufficient amount of oxygen for the electrochemical reaction) and a water pump. These devices may, in some embodiments, either be placed separately in case of a 20 ft container (see FIG. 3A) or inside the battery container in case of a 40 ft container (see FIG. 3B). In embodiments where a relatively low number of modules are employed, the devices may be placed inside a 20 ft container with the modules. The use of a 40 ft container may allow for the number of cells and modules to be further increased. Generally, the size of the battery is not particularly limited, and may comprise a number of containers connected—either in series or in parallel.

The air compressor of one or more embodiments is able to supply air in an amount ranging from a lower limit of 150, 200, 220, or 240 m³/h to an upper limit of 250, 275, or 300 m³/h, where any lower limit may be used in combination with any upper limit, at a pressure ranging from about 450 to 550 mbar.

One of ordinary skill in the art will appreciate, with the benefit of this disclosure, that batteries in accordance with the present disclosure are not limited to those disclosed above and may be adjusted according to the specific requirements of their application. Batteries in accordance with the present disclosure may exhibit an exceptional capacity retention upon cycling, which may be attributed to the continuous supply of fresh seawater for the electrochemical reaction upon cycling and the chemical stability of the materials used. Batteries of some embodiments may also be advantageously environmentally friendly compared to existing battery technologies.

### APPLICATIONS

A large-scale, cost-effective, and efficient design is introduced here for offshore applications and remote locations where cost, safety, installation, environmental concerns and long-term operation are critical.

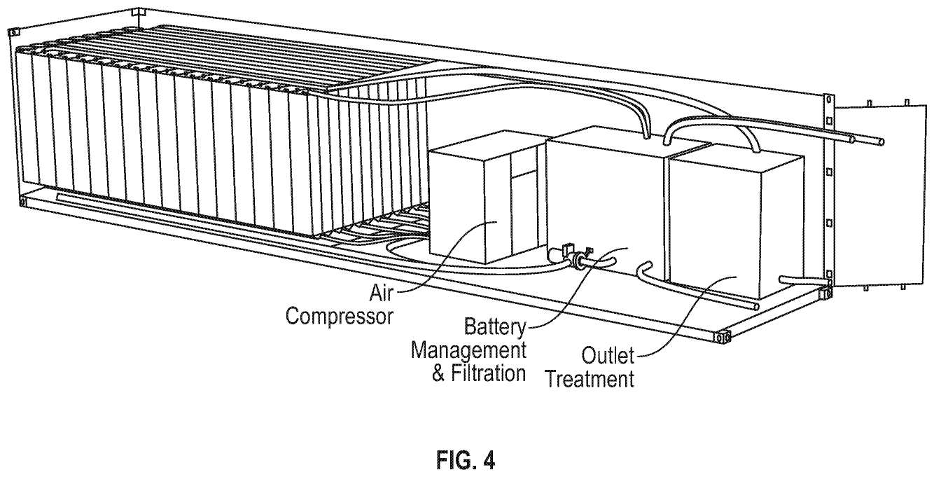

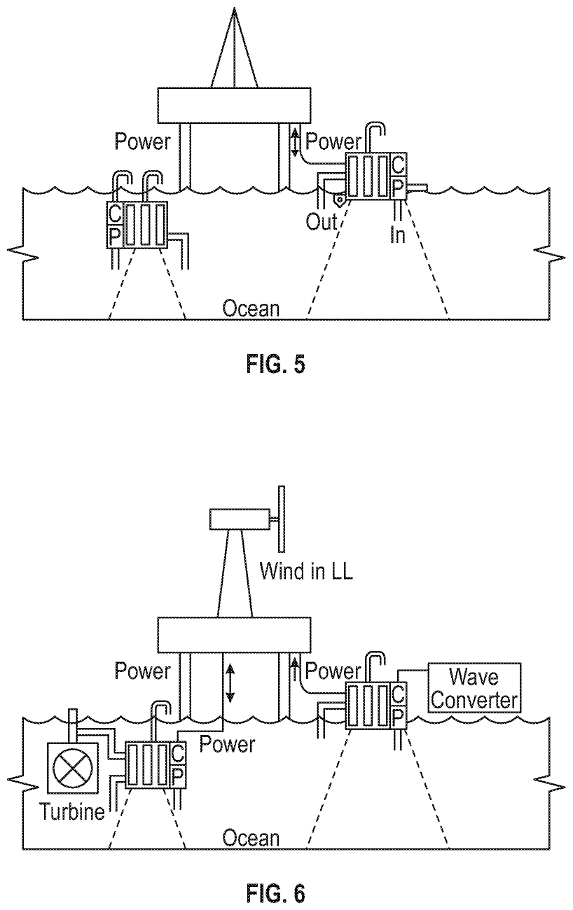

The battery of one or more embodiments may provide power storage for applications offshore and near shore in oil and gas platforms and rigs along with offshore wind mills, wave and tidal converters and current activated turbines. The battery of some embodiments may be easily incorporated into the existing systems. The battery can be installed near the offshore structure on a floating structure or semi submerged with protective barriers installed inside the container, between modules, and pump and compressor. Some of these applications are depicted in FIGS. 5 and 6. In embodiments where the battery is placed above sea level, seawater may be pumped through the modules.

Since the cathode of one or more embodiments is seawater, the battery may be safely transported to a site of end use as a module. Said module may comprise all the components of the battery except for the cathode (i.e. without seawater), reducing the cost of installation and deployment. The module may be charged with seawater on site to provide the battery. This may be beneficial for power storage applications in offshore and other remote, including near-shore, sites.

As the battery of one or more embodiments releases water with reduced salt levels, the battery may be used in processes such as desalination. For instance, the battery may be used in cleaning salt brines from desalination plants and fracking water when using the battery in a charging mode. Highly pure chlorine is also produced during charging and may be captured for further usage.

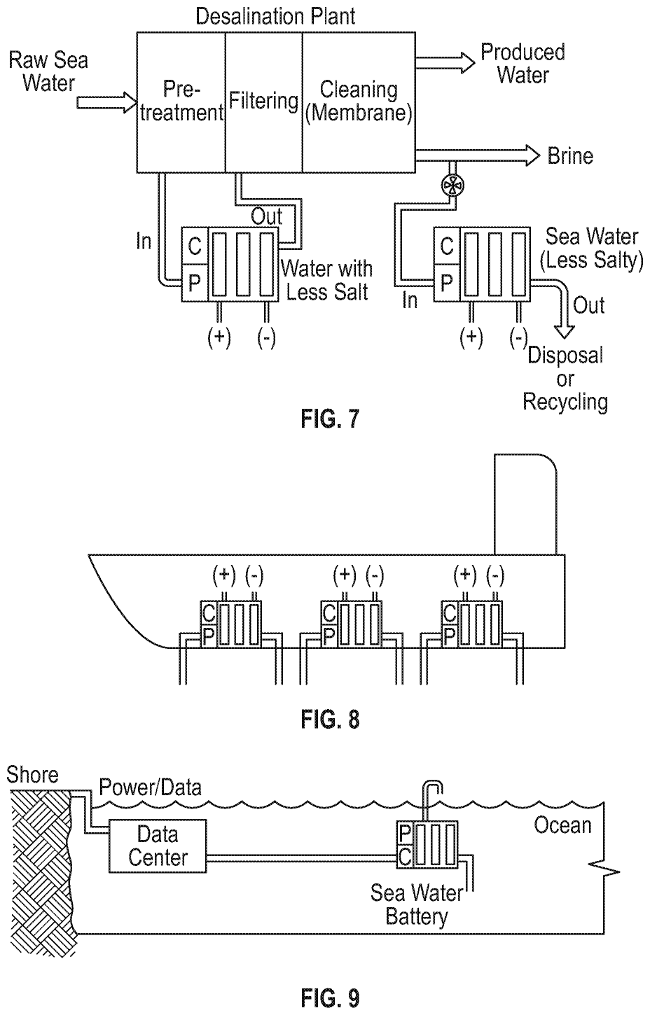

In some embodiments, the battery can be used at the seawater pre-treating stage of a desalination plant by diverting sea water to the battery for salt removal and reinjecting the water to the plant for more efficient filtering and desalination at the membrane. The battery can also be used to remove salt from the brine produced at the plant before being disposed to the ocean. This treatment of brines may help stabilize the salt levels of the local environment. FIG. 7 depicts a battery application in a desalination plant

The battery of one or more embodiments may also be integrated inside transporting vessels, cruise lines and barges to store power during cruising and supply power during idle times. The battery vessels can also be emptied (i.e., seawater removed) to reduce weight during cruising when the battery is not used. The battery may be charged when stationary. See FIG. 8.

Some data centers may be situated in subsea environments to limit the cooling that is required. The battery of one or more embodiments may be used to provide power storage for said data centers. In particular embodiments, the battery may provide back-up power to preserve data integrity. See FIG. 9.

The battery of some embodiments can also work without an additional supply of oxygen, instead slowly relying upon the oxygen that is dissolved in seawater. Said embodiments may be particularly directed to the use of the battery in subsea applications. In such case, it will include compensation tanks and barriers to protect systems for water ingression and to resist subsea pressures. In some instances, the battery may operate less efficiently without the additional supply of oxygen.

Although the preceding description has been described herein with reference to particular means, materials and embodiments, it is not intended to be limited to the particulars disclosed herein; rather, it extends to all functionally equivalent structures, methods and uses, such as are within the scope of the appended claims. In the claims, means-plus-function clauses are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures. It is the express intention of the applicant not to invoke 35 U.S.C. § 112(f) for any limitations of any of the claims herein, except for those in which the claim expressly uses the words ‘means for’ together with an associated function.

1. An electrochemical cell, the cell comprising:
an anode;
a porous anodic current collector;
a cathode;
a porous cathodic current collector; and
an alkali metal-conducting separator that separates the anode from the cathode and is disposed surrounding the anodic current collector,
wherein the cathode comprises seawater.

2. The electrochemical cell of claim 1, wherein the cell is tubular and at least one of the anodic current collector and the cathodic collector are cylindrical in shape.

3. The electrochemical cell of claim 2, wherein both the anodic current collector and the cathodic collector are cylindrical in shape.

4. The electrochemical cell of claim 3, wherein the anodic current collector is disposed within the cathodic current collector.

5. The electrochemical cell of claim 1, wherein the alkali metal-conducting separator is a sodium super ionic conductor film.

6. The electrochemical cell of claim 1, wherein the separator is disposed between, and contacts both, the anodic current collector and the cathodic current collector.

7. The electrochemical cell of claim 1, wherein the porous anodic current collector is a metal foam.

8. The electrochemical cell of claim 7, wherein the metal foam is aluminum foam.

9. The electrochemical cell of claim 1, wherein the anode is hard carbon.

10. The electrochemical cell of claim 1, wherein the porous cathodic current collector is carbon felt.

11. The electrochemical cell of claim 1, wherein the cell has a diameter in a range from about 5 to 25 mm.

12. The electrochemical cell of claim 1, wherein the cell has a length in a range from about 10 to 500 mm.

13. The electrochemical cell of claim 1, wherein the cell provides a voltage in a range from about 2 to 4 V.

14. A battery module, comprising a plurality of the electrochemical cells as recited in claim 1.

15. The battery module of claim 14, wherein the plurality of cells comprises a number of cells in a range from 10 to 500.

16. The battery module of claim 14, wherein the plurality of cells is connected in parallel.

17. The battery module of claim 14, wherein the battery module provides a current in a range from 100 to 700 A.

18. The battery module of claim 14, wherein the plurality of cells is connected by a metallic structure.

19. The battery module of claim 14, wherein the plurality of cells has a staggered arrangement.

20. A battery, comprising a plurality of the modules of claim 14.

21. The battery of claim 20, wherein the plurality of modules comprises a number of modules in a range from 50 to 250.

22. The battery of claim 20, wherein the battery modules are connected in series.

23. The battery of claim 20, wherein the battery has a capacity of about 0.5 MWh or more.

24. The battery of claim 20, wherein the battery provides a voltage in a range from about 400 to 700 V.

25. A battery, the battery comprising a plurality of electrochemical cells, wherein each electrochemical cell comprises:
a seawater cathode; and
a sodium super ionic conductor membrane, and
wherein the battery has a capacity of 3 MWh or more.

26. The battery according to claim 25, wherein each electrochemical cell further comprises:
a hard carbon anode;
an aluminum foam anodic current collector; and
a carbon felt cathodic current collector.

27. A desalination plant, comprising:
a pretreatment stage;
a filter;
a membrane; and
a seawater battery.

28. The desalination plant of claim 27, wherein the battery is connected to the pretreatment stage of the plant.

29. The desalination plant of claim 27, wherein the battery is connected after the membrane.

30. A method of generating electrical power, the method comprising:
transporting a module to a site;
adding seawater to the module at the site to provide a battery; and
generating electrical power with the battery,
wherein the module comprises all of the components of the battery except for the cathode.

31. A method of desalinating seawater, the method comprising:
flowing the seawater through a battery; and
charging the battery with the seawater,
wherein the battery comprises a plurality of electrochemical cells as recited in claim 1, wherein the separator is made of a sodium super ionic conductor membrane.

32. The method according to claim 31, wherein each electrochemical cell further comprises:
a hard carbon anode;
an aluminum foam anodic current collector; and
a carbon felt cathodic current collector.

33. The method according to claim 31, wherein the battery has a capacity of 1 MWh or more.

34. The method of claim 31, wherein the battery desalinates the seawater before the seawater is passed through a desalination membrane.

35. The method of claim 31, wherein the battery desalinates the seawater after the seawater is passed through a desalination membrane.
